(19) United States
(12) Patent Application Publication
(10) Pub. No.: US 2018/0332546 A1
(43) Pub. Date: Nov. 15, 2018

(54) COMMUNICATION TERMINAL

(71) Applicant: SHARP KABUSHIKI KAISHA, Sakai City, Osaka (JP)

(72) Inventor: TSUGUHIRO AOKI, Sakai City (JP)

(73) Assignee: SHARP KABUSHIKI KAISHA, Sakai City, Osaka (JP)

(21) Appl. No.: 15/774,672

(22) PCT Filed: Oct. 5, 2016
(86) PCT No.: PCT/JP2016/079651

§ 371 Date: May 9, 2018

(30) Foreign Application Priority Data
Nov. 16, 2015 (JP) 2015-223732

(51) Int. Cl. H04W 56/00; H04W 76/14; H04W 88/04; H04W 84/18; H04W 52/02; H04W 40/12; H04W 40/20; H04W 68/00; G01S 19/01

(52) U.S. Cl. CPC H04W 56/001; H04W 76/14; H04W 88/04; H04W 84/18; G01S 19/01; H04W 40/12; H04W 40/20; H04W 68/005; H04W 52/0219

(57) ABSTRACT

In a terminal-to-terminal communication system, each of communication terminals performs time synchronization by means of time information contained in a GPS signal received from a GPS satellite, and, with reference to the synchronized time, sets a notification period for transmission and reception of a notification signal, such as a beacon signal. In the notification period, each terminal transmits a beacon signal to other terminals, with the beacon signal containing the information indicating the timing for signal transmission. Each terminal has a function of relaying the terminal-to-terminal communication that takes place between other terminals. Each terminal determines a relay station by sharing, among the terminals and through transmission and reception of beacon signal, information such as positional information and electric field strength information of each terminal.

### TECHNICAL FIELD

The present application claims a priority based on Japanese Patent Application No. 2015-223732 filed on Nov. 16, 2015, the entire content of which is incorporated herein by reference.

The present disclosure relates to a system in which radio communication terminals communicate with one another, and particularly relates to a technology for controlling the timing of transmission and reception of signals among these plurality of terminals.

### BACKGROUND ART

A mobile communication system in which communication terminals perform radio communication via base stations (eNodeB) has been conventionally widely used. If a base station stops operating due to, for example, a large-scale disaster, such a communication system has a significant bad influence, such as communication failures of the communication terminals. Also, since the coverage of base stations is limited, communication via a base station may be difficult in some regions, such as mountainous regions. In view of this, a communication system in which communication terminals perform terminal-to-terminal (D2D: Device to Device) direct communication has been considered. For example, for D2D communication in Long Term Evolution (LTE), communication terminals are configured to carry out functions, such as terminal-to-terminal direct communication and a technology for discovering nearby terminals (device discovery).

Various technologies for constituting a communication network by such communication terminals communicating with one another have been considered. For example, Japanese Patent Laying-Open No. 2004-343509 (PTD 1) describes a radio communication system that builds an ad hoc network using a plurality of channels. According to the technology of PTD 1, a radio communication apparatus regularly scans a plurality of channels on a predetermined cycle, notifies the scanning timing and the channel information through a beacon signal, and notifies surrounding radio communication apparatuses of the status of utilization of all the channels.

### CITATION LIST

### Patent Document

PTD 1: Japanese Patent Laying-Open No. 2004-343509

### SUMMARY OF INVENTION

### Technical Problem

In the technology of PTD 1, however, the transmission of beacon signal is necessary when terminals around the radio communication apparatus are not performing scanning, and thus each terminal may needlessly consume power.

An object of the present disclosure is, in a system for communication among a plurality of terminals, to provide a technology for further reducing power consumption by controlling the timing at which signals are transmitted and received among the plurality of terminals.

### Solution to Problem

A communication terminal according to one embodiment includes a reception unit configured to receive a radio signal containing time information, and a control unit configured to control an operation of the communication terminal. The control unit is configured to, based on the time information, receive a beacon signal periodically at the same timing as another communication terminal for a certain period.

A communication terminal according to one embodiment is capable of performing terminal-to-terminal communication. The communication terminal includes a reception unit configured to receive a radio signal containing time information, and a control unit configured to control an operation of the communication terminal. The control unit includes: a beacon control unit configured to, based on the time information contained in the radio signal, set a notification period in which a beacon signal is to be transmitted and received to and from another terminal, and send the beacon signal in the notification period, with the beacon signal containing information indicating the timing at which the communication terminal is to transmit a beacon signal; and a timing control unit, configured to, in the notification period, receive the beacon signal sent from another terminal, and adjust the transmission timing of a radio signal of each terminal, based on information indicating the timing at which each terminal is to transmit a beacon signal, the information being contained in the received beacon signal.

According to another embodiment, a communication terminal capable of performing terminal-to-terminal communication is provided. At least any one of terminals capable of performing the terminal-to-terminal communication is configured to send a radio signal indicating reference timing. The communication terminal includes a reception unit configured to receive, from a specified terminal, the radio signal indicating the reference timing, and a control unit configured to control an operation of the communication terminal. The control unit includes: a beacon control unit configured to set a notification period in which a beacon signal is to be transmitted and received among terminals, based on information on the reference timing contained in the radio signal, and send the beacon signal in the notification period, with the beacon signal containing information indicating the timing at which the communication terminal is to transmit a beacon signal; and a timing control unit configured to, in the notification period, receive the beacon signal sent from each terminal, and adjust the transmission timing of the radio signal of each terminal based on information indicating the timing at which each terminal is to transmit the beacon signal, the information being contained in the received beacon signal.

### Advantageous Effects of Invention

According to one embodiment, the terminals synchronize with one another based on time information, and transmit and receive beacon signals at the same timing for a certain period of time. Accordingly, it is not necessary to perform transmission of beacon signal when surrounding terminals are not performing scanning. Therefore, power consumption can be further reduced.

The above and other objects, features, aspects and advantages of the present invention will be apparent from the following detailed description about the present invention that will be understood in connection with the attached drawings.

### BRIEF DESCRIPTION OF DRAWINGS

FIG. 1 shows a terminal-to-terminal communication system 1 of Embodiment 1.

FIG. 2 shows a case where each terminal determines the timing of transmission of notification signal with reference to a synchronized time and transmits a notification signal in accordance with the determination.

FIG. 3 is a block diagram showing a configuration of a communication terminal 10.

FIG. 4 shows a data structure of terminal management information 151 stored in a storage unit 150.

FIG. 5 is a flowchart showing processing where each terminal performs time synchronization; sets a notification period for transmission and reception of notification signal, based on the time information; and adjusts the transmission timing among the terminals.

FIG. 6 shows an aspect where each terminal sets a relay station for direct communication in Embodiment 2.

FIG. 7 shows a data structure of terminal management information 1511 of Embodiment 2.

FIG. 8 is a flowchart showing an operation of communication terminal 10 of Embodiment 2.

FIG. 9 shows an aspect where any one of the terminals performing terminal-to-terminal communication periodically transmits a reference beacon signal in Embodiment 3.

### DESCRIPTION OF EMBODIMENTS

Embodiments of the present invention will now be descried below with reference to the drawings. In the following description, the same components are denoted by the same reference characters and have the same names and functions. Thus, detailed explanation is not repeated for such components.

### Embodiment 1

In the present embodiment, terminal-to-terminal communication system 1 is described. Terminal-to-terminal communication system 1 includes terminals, such as a communication terminal 10A, a communication terminal 10B, a communication terminal 10C, and a communication terminal 10D (which may also be collectively referred to as “communication terminal 10” hereinafter), that perform device-to-device (D2D) direct communication. By supporting D2D communication based on a communication technology, such as Long Term Evolution (LTE), users can be provided with communication means when a base station is down or when a user is outside the coverage of base stations or is in other communication environments, for example. For example, D2D communication in LTE has a function of enabling data communication and voice telephonic communication between a terminal and a nearby terminal via direct communication, and a function of detecting other terminals and services around the terminal (device discovery).

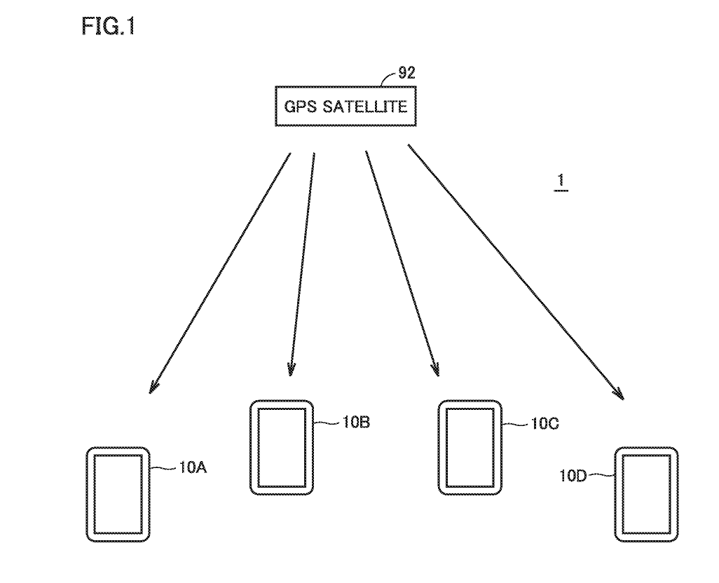

FIG. 1 shows terminal-to-terminal communication system 1 of Embodiment 1. As shown in FIG. 1, each terminal (communication terminal 10) constituting terminal-to-terminal communication system 1 receives a UPS signal sent from a global positioning system (UPS) satellite 92, a quasi-zenith satellite, and other satellites.

(Setting Period for Transmission and Reception of Notification Signal Based on UPS Signal)

Each terminal performs time synchronization with other terminals by means of time information contained in a GPS signal received from a satellite. Each terminal periodically sets a notification period based on the synchronized time, the notification period being a period for transmission of a notification signal, such as a beacon signal, to other terminals, and for reception of notification signal from other terminals. The notification period is a predetermined length of time.

(Transmission Timing of Beacon Signal)

Each terminal determines the timing of transmission of notification signal based on the synchronized time. In a notification period based on a predetermined time, each terminal transmits a notification signal to surrounding terminals, with the notification signal containing the information on a length of time by which the timing of transmission of beacon signal is shifted from the reference time (i.e., the information on the transmission timing of beacon signal). For example, in the case of FIG. 1, communication terminal 10A transmits a notification signal to surrounding terminals, with the notification signal containing transmission of beacon signal at the reference time (i.e., the shift amount from the reference time is “0”). Further, communication terminal 10B incorporates, in a notification signal, the timing of transmission of beacon signal being shifted from the reference time by a length of time “α”. Communication terminal 10C incorporates, in a notification signal, the timing of transmission of beacon signal being shifted from the reference time by a length of time “2α”. Communication terminal 10D incorporates, in a notification signal, the timing of transmission of beacon signal being shifted from the reference time by a length of time “3α”.

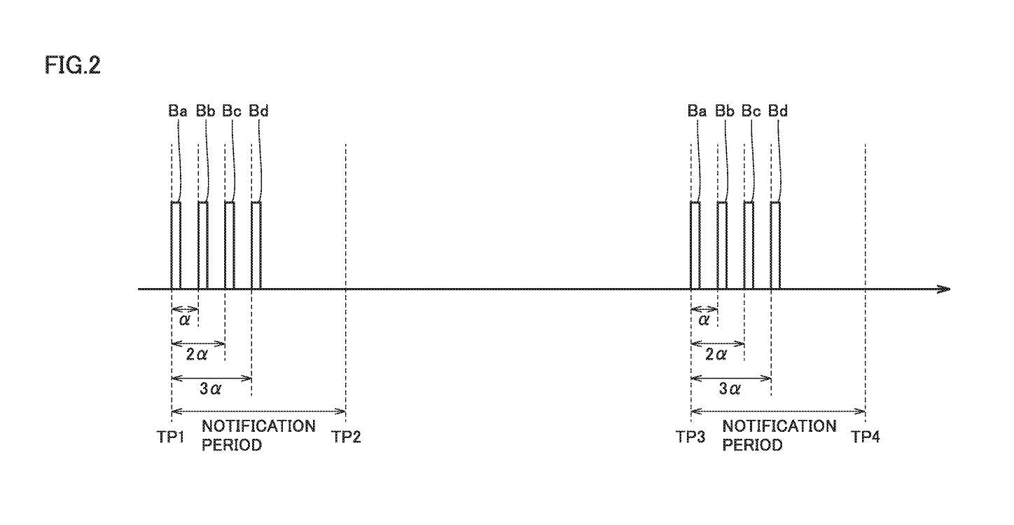

FIG. 2 shows a case where each terminal determines the timing of transmission of notification signal with reference to a synchronized time, and transmits a notification signal in accordance with the determination. In FIG. 2, the horizontal axis represents time. Communication terminal 10 sets a notification period (period from time TP1 to time TP2 and period from time TP3 to time TP4) based on a synchronized time. Communication terminal 10A transmits a beacon signal Ba at a reference time (time TP1 or time TP3). Communication terminal 10B transmits a beacon signal Bb at the timing shifted from the reference time by a length of time “α”. Communication terminal 10C transmits a beacon signal Bc at, the timing shifted from the reference time by a length of time “2α”. Communication terminal 10D transmits a beacon signal Bd at the timing shifted from the reference time by a length of time “3α”.

(Search Operation)

Further, each terminal performs a search in order to transmit a notification signal and to receive notification signals from surrounding terminals in a notification period that has been set based on a synchronized time.

In the present embodiment, each terminal incorporates positional information in a notification signal, the positional information being obtained by using GPS satellite 92. Further, in terminal-to-terminal communication system 1, if a coincidence of beacon signals transmitted from terminals is detected (for example, each terminal detects a coincidence of beacon signals by means of the information on the transmission timing of beacon signal contained in a notification signal), the coincidence is avoided by changing the transmission timing of at least any one of the terminals whose transmission timings of beacon signals would coincide. For example, if a coincidence of beacon signals is detected, the coincidence may be avoided in a Request to Send (RTS)/Clear to Send (CTS) method. Further, each terminal may allow the duration of notification period to vary depending on increase and decrease in the number of surrounding terminals with which the terminal can communicate. For example, the notification period is made longer with an increase in the number of surrounding terminals with which the terminal can communicate, whereas the notification period is made shorter with a decrease in the number. Also, the cycle of notification period may be variable depending on the amount of movement of terminal. The cycle is made longer when a terminal stands still or moves a little, whereas the cycle is made shorter when a terminal moves a lot. The amount of movement is measured by a difference from the previous positional information of the terminal.

<Configuration>

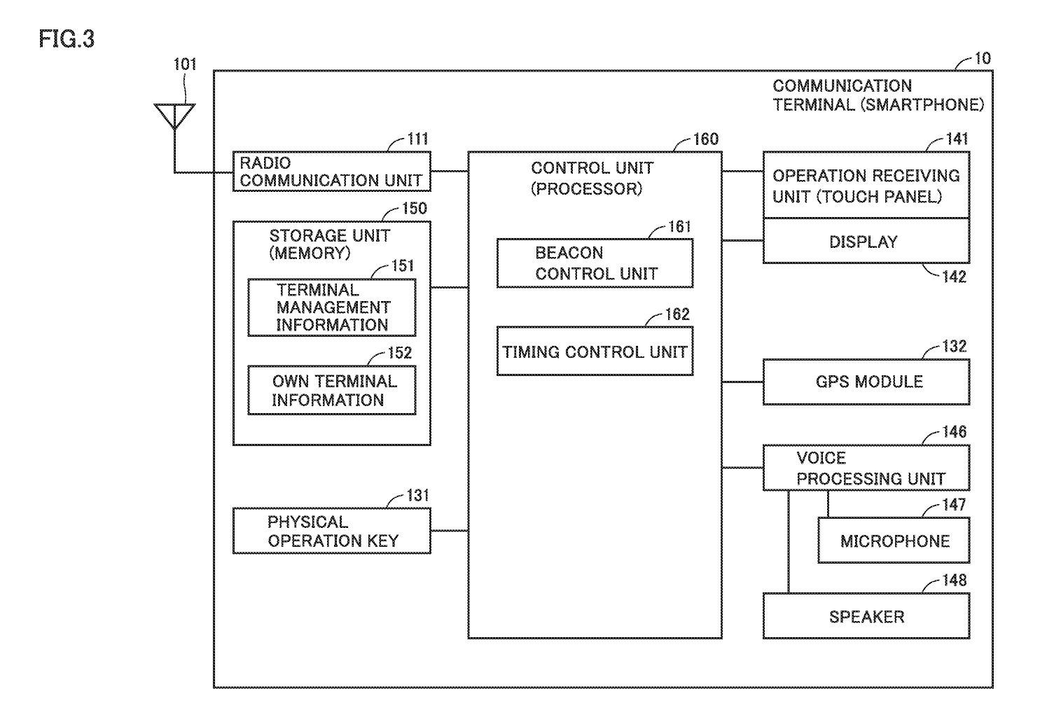

FIG. 3 is a block diagram showing a configuration of communication terminal 10.

As shown in FIG. 3, communication terminal 10 includes an antenna 101, a radio communication unit 111, a physical operation key 131, a UPS module 132, an operation receiving unit (touch panel) 141, a display 142, a voice processing unit 146, a microphone 147, a speaker 148, a storage unit 150, and a control unit 160.

Antenna 101 radiates a signal to be emitted by communication terminal 10 as a radio wave. Further, antenna 101 receives a radio wave from the space, and supplies a reception signal to radio communication unit 111. In the present embodiment, communication terminal 10 is in conformity with a plurality of radio communication standards.

Radio communication unit 111 performs, for example, modulation and demodulation for transmission and reception of signal via, for example, antenna 101, so that communication terminal 10 can communicate with other radio equipment. Radio communication unit 111 is a communication module including, for example, a tuner, a received signal strength indicator (RSSI) calculating circuit, a cyclic redundancy check (CRC) calculating circuit, and a high-frequency circuit. Radio communication unit 111 modulates and demodulates a radio signal to be transmitted from and received by communication terminal 10, performs frequency conversion, and supplies a reception signal to control unit 160.

Physical operation key 131 is a physical input unit and receives a pressing operation from a user. In response to a pressing operation from a user, physical operation key 131 outputs a signal indicating the content of operation, to control unit 160.

Operation receiving unit 141 receives an input operation from a user. Operation receiving unit 141 detects a position touched by a user by using, for example, a capacitive touch panel. Operation receiving unit 141 outputs, to control unit 160, a signal indicating the detected position touched by a user as an input operation.

Display 142 displays data, such as images, videos, and texts, in accordance with the control by control unit 160. Display 142 is implemented by, for example, a liquid crystal display (LCD) or an organic electroluminescence (EL) display.

Voice processing unit 146 modulates and demodulates a voice signal. Voice processing unit 146 modulates a signal supplied from microphone 147, and supplies the modulated signal to control unit 160. Also, voice processing unit 146 supplies a voice signal to speaker 148. Voice processing unit 146 is implemented by, for example, a processor for voice processing. Microphone 147 receives a voice input and supplies a voice signal corresponding to the voice input to voice processing unit 146. Speaker 148 converts a voice signal supplied from voice processing unit 146 and outputs the voice to the outside of communication terminal 10.

Storage unit 150 is constituted of, for example, a flash memory, and stores data and programs to be used by communication terminal 10. In one aspect, storage unit 150 stores terminal management information 151 and own terminal information 152.

Terminal management information 151 is the information for managing information, such as the information on the transmission timing of beacon signal and positional information, contained in a notification signal transmitted from and received by each terminal.

Own terminal information 152 is the information on the own terminal, such as the information on the transmission timing of beacon signal that is set by communication terminal 10, the information for identifying the own terminal, and the information on the length of time that is set as a notification period.

Control unit 160 reads a program stored in storage unit 150 and executes instructions contained in the program, thereby controlling the operation of communication terminal 10. Control unit 160 is, for example, a processor. Control unit 160 operates in accordance with the program, thereby carrying out functions as beacon control unit 161 and timing control unit 162.

Beacon control unit 161 sets a notification period in which a beacon signal is to be transmitted and received to and from another terminal, based on time information contained in a radio signal, such as a GPS signal, received from GPS satellite 92. In the notification period, beacon control unit 161 sends a beacon signal from antenna 101 as a radio signal, with the beacon signal containing the information indicating the timing at which communication terminal 10 is to transmit a beacon signal. Beacon control unit 161 sets the duration of notification period in accordance with increase and decrease in the number of terminals with which communication terminal 10 can communicate and identified by receiving a beacon signal sent from each terminal.

In a notification period, timing control unit 162 receives a beacon signal sent from another terminal, and adjusts the transmission timing of radio signal of each terminal, based on the information indicating the timing at which each terminal is to transmit a beacon signal, the information being contained in the received beacon signal.

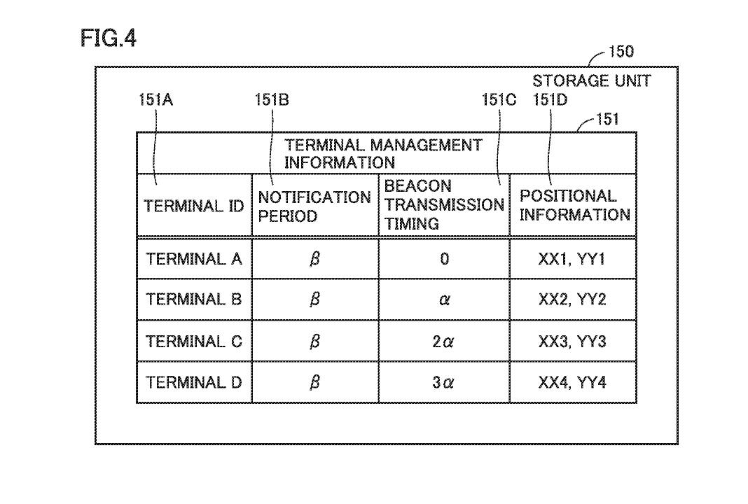

FIG. 4 shows a data structure of terminal management information 151 stored in storage unit 150. As shown in FIG. 4, each record of terminal management information 151 includes terminal identification information 151A, notification period 151B, beacon transmission timing 151C, and positional information 151D.

Terminal identification information 151A indicates the information for identifying each terminal and contained in a beacon signal which each terminal has received from another terminal. Terminal identification information 151A provides a list of terminals, including the own terminal, with which the own terminal can perform D2D communication through transmission and reception of beacon signal.

Notification period 151B indicates the duration of period that is set by each terminal as a notification period. For example, communication terminal 10 holds the setting of the duration of notification period in own terminal information 152.

Beacon transmission timing 151C indicates the timing at which each terminal is to transmit a beacon signal based on a reference time in a notification period.

Positional information 151D is the information on a position of each terminal identified by a GPS signal that each terminal receives from GPS satellite 92.

<Operation>

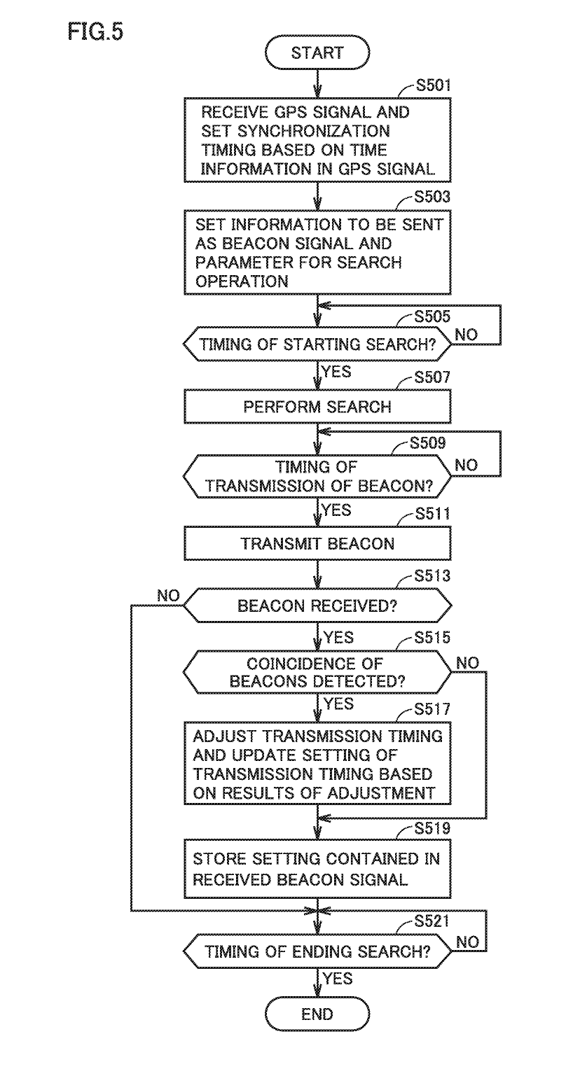

With reference to FIG. 5, an operation of communication terminal 10 constituting terminal-to-terminal communication system 1 of the present embodiment will now be described.

FIG. 5 is a flowchart showing processing where each terminal performs time synchronization; sets a notification period for transmission and reception of notification signal, based on the time information; and adjusts the transmission timing among the terminals. Each terminal performs the processing shown in FIG. 5 repeatedly on a predetermined cycle, for example.

At Step S501, communication terminal 10 receives a GPS signal from GPS satellite 92, and sets the synchronization timing among the terminals based on the time information contained in the received GPS signal. Communication terminal 10 sets a notification period, with a predetermined time serving as a reference, for example.

At Step S503, based on the reference time, communication terminal 10 sets information (beacon transmission timing 151C) indicating the timing of transmission of beacon signal, and sets a parameter for a search in a notification period.

At Step S505, communication terminal 10 determines whether it is the timing of starting a search for another terminal in a notification period. If it is the timing of starting a search (YES at Step S505), communication terminal 10 performs the processing of Step S507; and otherwise (NO at Step S505), communication terminal 10 waits till the timing of starting a search.

At Step S507, communication terminal 10 searches for another terminal. At Step S509, communication terminal 10 determines whether or not it is the timing of transmitting a beacon signal (beacon transmission timing 151C) in a notification period. If it is the timing of transmitting a beacon signal (YES at Step S509), communication terminal 10 performs the processing of Step S511; and otherwise (NO at Step S509), communication terminal 10 waits till the timing of transmission of beacon signal.

At Step S511, communication terminal 10 transmits a beacon signal in accordance with the timing of transmission of beacon signal.

At Step S513, communication terminal 10 determines whether or not a beacon signal has been received from another terminal in a notification period. If a beacon signal has been received from another terminal (YES at Step S513), communication terminal 10 performs the processing of Step S515; and otherwise (NO at Step S513), communication terminal 10 performs the processing of Step S521.

At Step S515, communication terminal 10 determines, based on terminal management information 151, for example, whether or not the timing of sending of beacon signal coincides with that of another terminal when the own terminal sends a beacon signal in a notification period. If beacon signals coincide (YES at Step S515), communication terminal 10 performs the processing of Step S517; and otherwise (NO at Step S515), communication terminal 10 performs the processing of Step S519.

At Step S517, in accordance with, for example, an RTS/CTS method, communication terminal 10 adjusts the transmission timings of signals between the terminals whose transmission timings of beacon signals would coincide with each other. Based on the results of adjustment, communication terminal 10 updates the setting of transmission timing (beacon transmission timing 151C).

At Step S519, communication terminal 10 updates terminal management information 151 based on the information contained in a beacon signal received from each terminal in a notification period.

At Step S521, communication terminal 10 determines whether or not it is the timing of ending a search for another terminal. If it is the timing of ending a search (YES at Step S521), communication terminal 10 ends the processing; and otherwise (NO at Step S521), communication terminal 10 continues a search for another terminal.

### Summary of Embodiment 1

According to terminal-to-terminal communication system 1 of Embodiment 1, each terminal performs time synchronization with surrounding terminals, and, based on the synchronized time, sets a notification period for transmission and reception of a notification signal, such as a beacon signal. Accordingly, each terminal does not need to transmit a beacon signal when surrounding terminals are not performing scanning. Therefore, unnecessary power consumption, due to unnecessary sending of beacon signal when surrounding terminals are not performing scanning, can be avoided.

### Embodiment 2

Another embodiment will now be described.

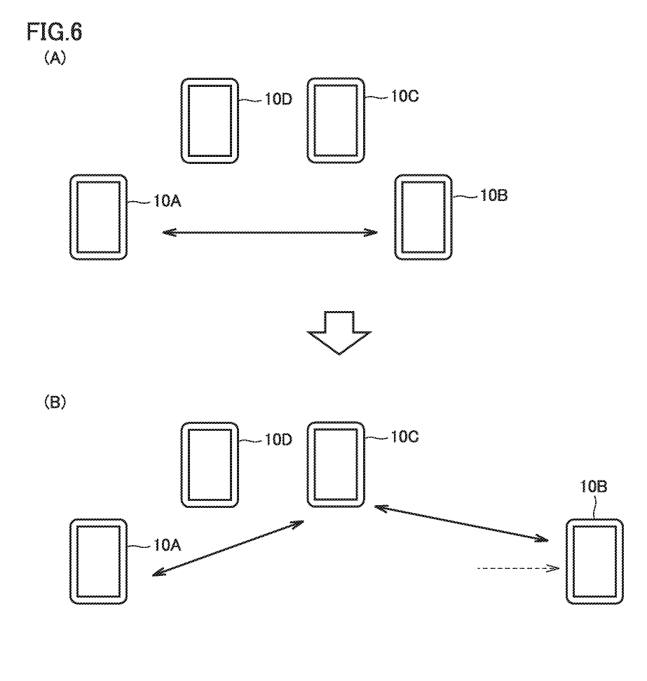

FIG. 6 shows an aspect where each terminal sets a relay station for direct communication in Embodiment 2.

The state (A) of FIG. 6 shows an aspect where communication terminal 10A and communication terminal 10B are in direct communication with each other. The state (B) of FIG. 6 shows an aspect where communication terminal 10B in state (A) has moved and thus communication terminal 10A and communication terminal 10B are separated from each other by a longer distance than then can directly communicate with each other, so that they have selected communication terminal 10C as a relay station.

In Embodiment 2, each terminal sends a beacon signal, with the beacon signal containing the information on the electric field strength of signal received from another terminal with which the terminal can communicate. Thus, each terminal can share the electric field strength information received from another terminal and exchanges possible routes of data. At the end of a notification period as described in Embodiment 1, which terminal relays communication between which terminals is autonomously determined by each terminal itself, in accordance with a criterion shared among the terminals in advance.

In the case of state (B) of FIG. 6, communication terminal 10C and communication terminal 10D are present between communication terminal 10A and communication terminal 10B. In a notification period, each terminal sends a beacon signal, with the beacon signal containing the positional information based on a GPS signal and the electric field strength information received from another terminal. Each terminal receives a beacon signal from another terminal and thus obtains the positional information and the electric field strength information of another terminal. Each terminal holds such information contained in a beacon signal received from each terminal.

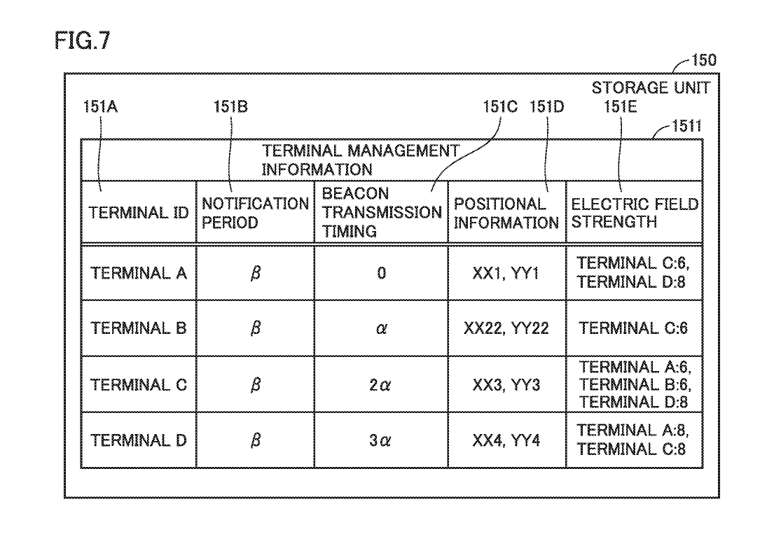

FIG. 7 shows a data structure of terminal management information 1511 of Embodiment 2. In terminal management information 1511, electric field strength 151E indicates the electric field strength of a signal which each terminal receives from another terminal. For example, in the case of state (B) of FIG. 6, communication terminal 10A receives beacon signals from communication terminal 10C and communication terminal 10D; obtains the positional information of communication terminal 10C and the electric field strength information of communication terminal 10A, communication terminal 10B, and communication terminal 10D with which communication terminal 10C can communicate; and obtains the positional information of communication terminal 10D and the electric field strength information of communication terminal 10A and communication terminal 10C with which communication terminal 10D can communicate. Also, communication terminal 10B receives a beacon signal from communication terminal 10C; and obtains the positional information of communication terminal 10C and the electric field strength information of communication terminal 10A, communication terminal 10B, and communication terminal 10D with which communication terminal 10C can communicate. In this way, communication terminal 10A can identify communication terminal 10C as being capable of communicating with communication terminal 10B, and communication terminal 10B can identify communication terminal 10C as being capable of communicating with communication terminal 10A. Communication terminal 10A and communication terminal 10B determine communication terminal 10C as a relay station. After a lapse of notification period, if a relay station has been determined, communication terminal 10A and communication terminal 10B perform terminal-to-terminal communication, with communication terminal 10C serving as a relay station.

If there are a plurality of communication terminals 10 that can serve as relay stations for relaying the communication between communication terminal 10A and communication terminal 10B, communication terminal 10A and communication terminal 10B may determine, as a relay station, the one closest to the intermediate point between communication terminal 10A and communication terminal 10B, for example. Also, communication terminal 10A and communication terminal 10B may determine, as a relay station, the one having the strongest electric field strength with communication terminal 10A and communication terminal 10B. Further, in a case where communication terminal 10A and communication terminal 10B communicate with each other via a relay station, different terminals may be determined as respective relay stations for the upstream of data and the downstream of data.

<Operation>

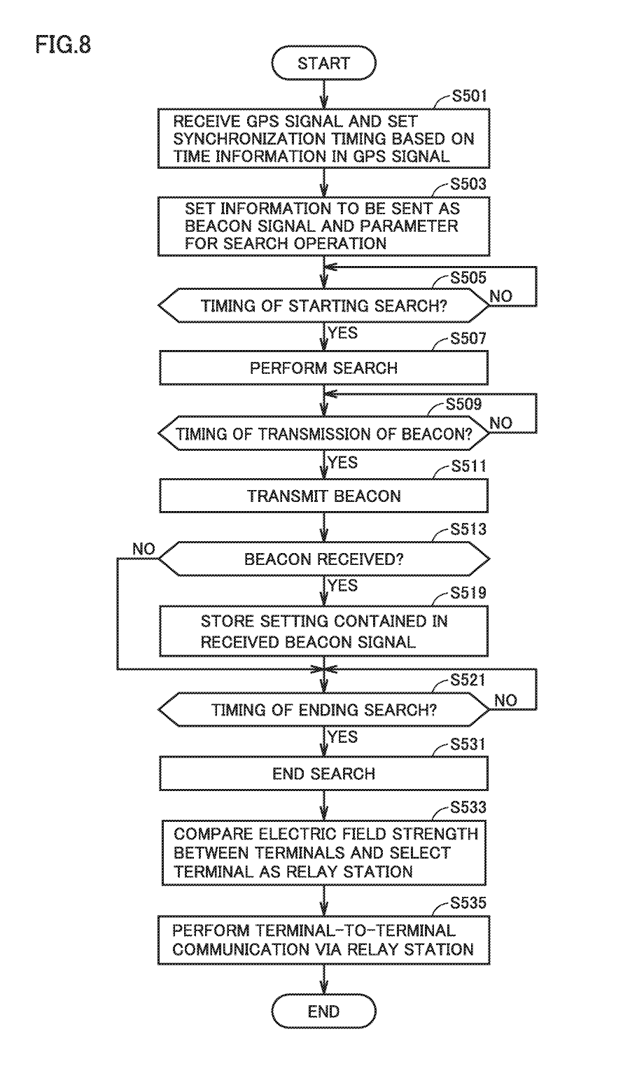

With reference to FIG. 8, an operation of communication terminal 10 of Embodiment 2 will now be described.

FIG. 8 is a flowchart showing an operation of communication terminal 10 of Embodiment 2.

At Step S513, communication terminal 10 determines whether or not a beacon signal has been received from another terminal m a notification period. If a beacon signal has been received from another terminal (YES at Step S513), communication terminal 10 performs the processing of Step S519; and otherwise (NO at Step S513), communication terminal 10 performs the processing of Step S521.

At Step S521, communication terminal 10 determines whether or not it is the timing of ending a search for another terminal. If it is the timing of end of a search (YES at Step S521), communication terminal 10 performs the processing of Step S531; and otherwise (NO at Step S521), communication terminal 10 continues a search for another terminal.

At Step S533, communication terminal 10 refers to terminal management information 1511, and selects a terminal for serving as a relay station based on the information on the electric field strength of signal which each terminal receives from another terminal.

At Step S535, communication terminal 10 performs terminal-to-terminal communication via the relay station selected at Step S533.

### Summary of Embodiment 2

Each terminal (communication terminal 10) that performs terminal-to-terminal communication has a function of relaying communication between terminals. Each terminal receives a GPS signal sent from GPS satellite 92 as a radio signal. A beacon signal sent from beacon control unit 161 contains positional information identified by a GPS signal, and information indicating a quality (electric field strength) of a signal which communication terminal 10 receives from another terminal with which communication terminal 10 can communicate. Control unit 160 determines a terminal for relaying communication between terminals, based on the positional information of another terminal with which communication terminal 10 can communicate and based on the information indicating a quality of a signal which another terminal, with which the communication terminal 10 can communicate, receives from a terminal, with which the another terminal can communicate, the positional information and the information indicating a quality of signal being contained in the received beacon signal. If there are a plurality of potential terminals for relaying communication between terminals, control unit 160 determines a terminal as a relay, based on at least any one of the positional information and the information indicating a quality of a signal contained in a beacon signal sent from each of the potential terminals.

### Embodiment 3

Another embodiment will now be described.

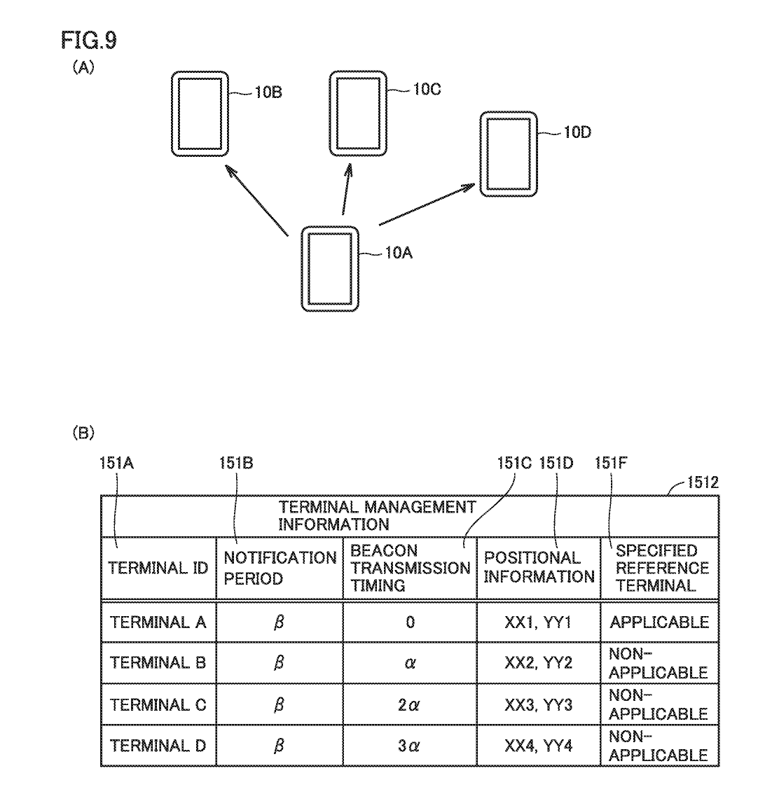

FIG. 9 shows an aspect where any one of the terminals performing terminal-to-terminal communication periodically transmits a reference beacon signal in Embodiment 3. The state (A) of FIG. 9 shows an aspect where communication terminal 10A transmits a reference beacon signal to other terminals. The state (B) shows terminal management information 1512 held in each terminal. Terminal management information 1512 contains a specified reference terminal 151E indicating which of the terminals performing terminal-to-terminal communication is a terminal that transmits a reference beacon signal.

In terminal-to-terminal communication system 1 of Embodiment 1, each terminal performing terminal-to-terminal communication performs time synchronization based on a UPS signal received from UPS satellite 92, and transmits and receives a beacon signal in a notification period based on the synchronized time. As opposed to this, in Embodiment 3, one of a group of terminals performing terminal-to-terminal communication periodically transmits a reference beacon signal. Another terminal in the group regards a certain period from the reception of the reference beacon signal as a notification period, determines the transmission timing of beacon signal (beacon transmission timing 151C), and transmits a beacon signal.

Each terminal that performs terminal-to-terminal communication determines a terminal for transmitting a reference beacon signal, in accordance with a certain rule. For example, each terminal determines, as a terminal for transmitting a reference beacon signal, a terminal having the smallest terminal ID value in the group of terminals performing terminal-to-terminal communication when the terminal IDs are arranged in an ascending or descending order. Alternatively, each terminal may refer to positional information 151D and determine, as a terminal for transmitting a reference beacon signal, a terminal having the smallest distance from the central point obtained by calculating the average value of the coordinate values of the terminals.

### Summary of Embodiment 3

Communication terminal 10 described in Embodiment 3 determines any one of the terminals capable of performing terminal-to-terminal communication, as a specified reference terminal for sending a reference beacon signal (i.e., a radio signal indicating reference timing). Communication terminal 10 receives a reference beacon signal from the specified reference terminal. Based on the reference beacon signal received from the specified reference terminal, communication terminal 10 sets a notification period for transmission and reception of beacon signal among the terminals. In the notification period, communication terminal 10 sends a beacon signal, with the beacon signal containing the information (beacon transmission timing 151C) indicating the timing at which communication terminal 10 is to transmit a beacon signal.

Each device constituting a system according to the embodiments is implemented by a processor and a program to be executed on the processor. A program implementing the embodiments is provided, for example, through transmission and reception using a network via a communication interface.

It should be construed that the embodiments disclosed herein are given by way of example in all respects, not by way of limitation. It is intended that the scope of the present invention is defined by the claims, not by the above description, and encompasses all modifications equivalent in meaning and scope to the claims.

### REFERENCE SIGNS LIST

10: communication terminal; 92: GPS satellite; 101: antenna; 111: radio communication unit; 131: physical operation key; 132: GPS module; 141: operation receiving unit; 142: display; 146: voice processing unit; 147: microphone; 148: speaker; 150: storage unit; 151: terminal management information; 152: own terminal information; 160: control unit; 161: beacon control unit; 162: timing control unit

1. A communication terminal comprising:
a reception unit configured to receive a radio signal containing time information; and
a control unit configured to control an operation of the communication terminal,
the control unit being configured to, based on the time information, receive a beacon signal periodically at the same timing as another communication terminal for a certain period.

2. The communication terminal according to claim 1, wherein
the control unit is configured to:
receive a beacon signal transmitted from another terminal in the certain period;
transmit a beacon signal in the certain period, with the beacon signal containing information on timing at which an own terminal is to transmit a beacon signal, and
when a received beacon signal contains information on timing at which the other terminal is to transmit a beacon signal, adjust timing at which the communication terminal is to transmit a beacon signal, based on the information on timing at which the other terminal is to transmit a beacon signal.

3. The communication terminal according to claim 1, wherein
the communication terminal is capable of performing terminal-to-terminal communication, and
the control unit includes:
a beacon control unit configured to, based on the time information contained in the radio signal, set a notification period in which a beacon signal is to be transmitted and received to and from another terminal, and send the beacon signal in the notification period, with the beacon signal containing information indicating timing at which the communication terminal is to transmit a beacon signal; and
a timing control unit configured to, in the notification period, receive the beacon signal sent from another terminal, and adjust transmission timing of a radio signal of each terminal, based on information indicating dining at which each terminal is to transmit the beacon signal, the information being contained in the received beacon signal.

4. The communication terminal according to claim 3, wherein
setting the notification period by the beacon control unit of the control unit includes setting duration of the notification period in accordance with increase and decrease of the number of terminals with which the communication terminal can communicate and identified by receiving the beacon signal sent from each terminal.

5. The communication terminal according to claim 3, wherein
each terminal that performs the terminal-to-terminal communication has a function of relaying communication between terminals,
the reception unit is configured to receive a GPS signal sent from a global positioning system (GPS) satellite as the radio signal,
the beacon signal sent from the beacon control unit of the control unit contains positional information identified by the GPS signal, and information indicating a quality of a signal which the communication terminal receives from a terminal with which the communication terminal can communicate, and
the control unit is configured to determine a terminal for relaying communication between terminals, based on the positional information of a terminal with which the communication terminal can communicate and based on the information indicating a quality of a signal which the terminal receives from another terminal, the positional information and the information indicating a quality of a signal being contained in the received beacon signal.

6. The communication terminal according to claim 5, wherein
the control unit is configured to, when there are a plurality of potential terminals for relaying communication between terminals, determine the terminal for relaying based on at least any one of the positional information and the information indicating a quality of a signal contained in the beacon signal sent from each of the potential terminals.

7. A communication terminal capable of performing terminal-to-terminal communication,
at least any one of terminals capable of performing the terminal-to-terminal communication being configured to send a radio signal indicating reference timing,
the communication terminal comprising:
a reception unit configured to receive, from a specified terminal, the radio signal indicating the reference timing; and
a control unit configured to control an operation of the communication terminal,
the control unit including:
a beacon control unit configured to, based on information on the reference timing contained in the radio signal, set a notification period in which a beacon signal is to be transmitted and received among terminals, and send the beacon signal in the notification period, with the beacon signal containing information indicating timing at which the communication terminal is to transmit a beacon signal; and
a timing control unit configured to, in the notification period, receive the beacon signal sent from each terminal, and adjust transmission timing of the radio signal of each terminal based on information indicating timing at which each terminal is to transmit the beacon signal, the information being contained in the received beacon signal.
